(19) United States
(12) Patent Application Publication
(10) Pub. No.: US 2017/0160481 A1
(43) Pub. Date: Jun. 8, 2017

(54) MODE SIZE CONVERTER AND OPTICAL DEVICE HAVING THE SAME

(71) Applicant: TYCO ELECTRONICS CORPORATION, Berwyn, PA (US)

(72) Inventors: Tao Ling, Harrisburg, PA (US); Jonathan Lee, Harrisburg, PA (US)

(21) Appl. No.: 15/005,454

(22) Filed: Jan. 25, 2016

Related U.S. Application Data
(60) Provisional application No. 62/263,455, filed on Dec. 4, 2015.

(51) Int. Cl. G02B 6/30; G02B 6/122; G02B 6/14

(52) U.S. Cl. CPC G02B 6/305; G02B 6/14; G02B 6/1221

(57) ABSTRACT

Mode size converter includes a first coupler having a signal waveguide that has a first inverse taper portion and an intermediate waveguide that overlaps the first inverse taper portion. The intermediate waveguide has a refractive index that is less than a refractive index of the signal waveguide. The mode size converter also include a second coupler having the intermediate waveguide and an overlay waveguide. The intermediate waveguide has a second inverse taper portion. The overlay waveguide overlaps the second inverse taper portion. The overlay waveguide has a refractive index that is less than the refractive index of the intermediate waveguide. The first and second couplers are configured to change a mode size of light propagating through the mode size converter. The mode size of the light through the overlay waveguide is configured to match a mode size of a single-mode fiber.

### CROSS-REFERENCE TO RELATED APPLICATION

The present application claims the benefit of U.S. Provisional Application No. 62/263,455, filed on Dec. 4, 2015, which is incorporated herein by reference in its entirety.

### BACKGROUND OF THE INVENTION

The subject matter herein relates generally to mode size converters that change a mode size of propagating light therethrough and optical devices including the mode size converters.

Increasing demands on high speed data transfer require new interconnect architectures and implementations. Optical interconnects are key components in these new system architectures because of their bandwidth advantage over copper. Recently, silicon photonics (SiP) has drawn a lot of attention as an enabling technology for high-density, low-power optical integration. This new technology platform uses large-scale complementary metal-oxide-semiconductor (CMOS) fabrication methods to integrate functional photonic devices into silicon chips in a cost effective manner. Such devices may be referred to as photonic integrated circuits (PICs) and may be used for various applications in optical communication, instrumentation, and signal-processing. A PIC may include submicron waveguides to interconnect various on-chip components, such as optical switches, couplers, routers, splitters, multiplexers/demultiplexers, modulators, amplifiers, wavelength converters, optical-to-electrical signal converters, and electrical-to-optical signal converters.

Although significant progress has been made in the fields of silicon-compatible optical interconnect and information processing technology, low loss coupling between optical fiber and high-index sub-micron silicon waveguide remains a challenge. For example, mode mismatch between a single-mode silicon waveguide and a standard single-mode fiber (SMF) is so large that it induces high coupling loss. To overcome the challenge there are two widely used strategies for efficient fiber-to-chip coupling: out-of-plane grating couplers and in-plane edge couplers with mode size converters. Most out-of-plane grating couplers have limited bandwidth which restricts their application(s) in broadband high-speed communication systems. On the other hand, in-plane edge coupling designs with mode size converters are calculated to achieve high coupling efficiency (e.g., greater than 90%) with more than 100 nanometer (nm) bandwidth.

There are typically two types of mode size converters that are capable of coupling light between a single-mode fiber and a sub-micron silicon waveguide: inverse taper couplers and segmented waveguide couplers. Both types are based on gradual modification of the silicon waveguide size that transforms the mode size of the light. Currently reported designs have demonstrated coupling efficiencies in excess of 90%.

Although such conventional mode size converters can sufficiently change the mode size, the mode size converters may have some challenges or drawbacks. For example, the mode size converter may have a coupling efficiency that is insufficient, may have a low alignment tolerance, and/or may be commercially impractical to manufacture. In particular, segmented waveguide couplers may require more complicated pattern design and fabrication processes. Similarly, commercially viable inverse taper couplers may require that the silicon waveguide taper to a tip that is about 15 nm wide or less. Such a small feature size (or node size) may be costly to manufacture.

Accordingly, there is a need for a mode size converter that has a sufficient coupling efficiency, a sufficient tolerance for alignment, and/or is not cost prohibitive to manufacture.

### BRIEF DESCRIPTION OF THE INVENTION

In accordance with a specific embodiment, a mode size converter is provided. The mode size converter includes a first coupler having a signal waveguide that has a first inverse taper portion and an intermediate waveguide that overlaps the first inverse taper portion. The intermediate waveguide has a refractive index that is less than a refractive index of the signal waveguide. The mode size converter also include a second coupler having the intermediate waveguide and an overlay waveguide. The intermediate waveguide has a second inverse taper portion. The overlay waveguide overlaps the second inverse taper portion. The overlay waveguide has a refractive index that is less than the refractive index of the intermediate waveguide. The first and second couplers are configured to change a mode size of light propagating through the mode size converter. The mode size of the light through the overlay waveguide is configured to match a mode size of a single-mode fiber.

In accordance with a specific embodiment, an optical device is provided that includes a first coupler having a signal waveguide that has a first inverse taper portion and an intermediate waveguide that overlaps the first inverse taper portion. The intermediate waveguide has a refractive index that is less than a refractive index of the signal waveguide. The optical device also includes a second coupler having the intermediate waveguide and an overlay waveguide. The intermediate waveguide has a second inverse taper portion. The overlay waveguide overlaps the second inverse taper portion. The overlay waveguide has a refractive index that is less than the refractive index of the intermediate waveguide. The first and second couplers form a mode size converter that is configured to change a mode size of light propagating therethrough.

Optionally, the optical device may also include a fiber support having a fiber-receiving channel that is configured to hold an optical fiber for communicating with the mode size converter. The fiber support may be held in a fixed position with respect to the mode size converter.

In accordance with a specific embodiment, a mode size converter design is formed by two cascade-connected inverse tapered couplers: one is a silicon nitride waveguide hybridized with a silicon inverse tapered waveguide to form the first coupler, and the second is a low index contrast polymer waveguide hybridized with the silicon nitride inverse tapered waveguide to form the second coupler.

These and other specific embodiments are described herein in conjunction with the following drawings, which are not necessarily drawn to scale.

### BRIEF DESCRIPTION OF THE DRAWINGS

FIG. 1 is a perspective view of an optical device having a mode size converter, according to a specific embodiment.

FIG. 2 illustrates a first cross-section of the mode size converter, in accordance with the specific embodiment, taken along the line 2-2 in FIG. 1.

FIG. 3 illustrates a second cross-section of the mode size converter, in accordance with the specific embodiment, taken along the line 3-3 in FIG. 1.

FIG. 4 is a perspective view of a three dimensional stack-up as the mode size converter of FIG. 1 is being fabricated, according to a specific embodiment. FIG. 4 illustrates a first inverse taper of a signal waveguide that is buried or embedded within another layer. Only a portion of the signal waveguide is shown in FIG. 4.

FIG. 5 illustrates the three dimensional stack-up of FIG. 4 after an intermediate waveguide is positioned to overlap the first inverse taper portion. The intermediate waveguide includes a second inverse taper portion.

FIG. 6 illustrates the three dimensional stack-up of FIG. 5 after an overlay waveguide is positioned to overlap the intermediate waveguide.

FIG. 7(a) is a top view of a simulated field intensity pattern along a first coupler of the mode size converter of FIG. 1.

FIG. 7(b) is a simulated field intensity pattern at a first cross-section of the first coupler of the mode size converter of FIG. 1.

FIG. 7(c) is a simulated field intensity pattern at a second cross-section of the first coupler of the mode size converter of FIG. 1.

FIG. 7(d) is a simulated field intensity pattern at a cross-section of the intermediate waveguide of the mode size converter of FIG. 1.

FIG. 8 is a graph showing a coupling efficiency of the first coupler of the mode size converter of FIG. 1 in relation to a length of the first inverse taper portion.

FIG. 9 is a top view of a simulated field intensity pattern along a second coupler of the mode size converter of FIG. 1.

FIG. 10(a) is a perspective view of a mode size converter, according to a specific embodiment.

FIG. 10(b) is a top view of a simulated field intensity pattern along a first coupler of the mode size converter of FIG. 10(a).

FIG. 10(c) is a top view of a simulated field intensity pattern along a second coupler of the mode size converter of FIG. 10(a).

FIG. 11(a) shows a simulated fiber coupling efficiency change with offset of the optical fiber in the vertical direction for the second coupler of FIG. 10(a).

FIG. 11(b) shows a simulated fiber coupling efficiency change with offset of the optical fiber in the horizontal direction for the second coupler of FIG. 10(a).

### DETAILED DESCRIPTION OF SPECIFIC EMBODIMENTS

Embodiments set forth herein include mode size converters and optical devices including mode size converters. The mode size converter is configured to change a mode size of light propagating therethrough. The mode size converter may be positioned between two optical components, such as a waveguide and an optical fiber. The waveguide may be, for example, a sub-micron silicon waveguide, and the optical fiber may be, for example, a single-mode fiber. In particular embodiments, the mode size converter may directly couple the waveguide and the optical fiber such that the light is not modified between the optical fiber and the mode size converter (e.g., by intervening aperture) or between the waveguide and the mode size converter. For example, the light may propagate directly from a sub-micron waveguide into the mode size converter and directly from the mode size converter to the optical fiber. It is contemplated, however, that one or more intervening elements may be used in some embodiments and/or other optical elements may be interconnected through the mode size converter.

The term “mode size” refers to a spatial distribution of light relative to a cross-sectional area that is oriented normal to the optical path (e.g., in a waveguide or optical fiber). Embodiments set forth herein include multiple inverse taper portions (or inverted taper portions) that are in series with one another. The inverse taper portions may have a cascaded configuration or relationship such that one inverse taper portion directly follows another. As such, embodiments may be described as having cascaded inverse taper couplers. In a first light-propagation direction, each inverse taper portion may cause the light to expand outside of the inverse taper portion and into an overlapping waveguide that has a less refractive index. In a second light-propagation direction that is opposite the first light-propagation direction, light propagating through the overlapping waveguide is coupled evanescently into the waveguide having the inverse taper portion. The light becomes progressively more confined as the inverse taper portion widens.

Due to the structural configuration of some embodiments, it may be possible to use more cost-effective manufacturing processes when fabricating the mode size converters and/or optical devices. For example, embodiments may include inverse taper waveguides in which a width of the distal end (or tip) of the inverse taper is greater than or equal to 15 nanometers (nm). In some embodiments, the width of the distal end may be greater than or equal to 20 nm, 30 nm, or 40 nm. In certain embodiments, the width of the distal end may be greater than or equal to 50 nm, 60 nm, 70 nm, or 80 nm. In particular embodiments, the width of the distal end may be greater than or equal to 90 nm or 100 nm or larger. By allowing for larger feature or node sizes, such as the distal ends or tips, less costly manufacturing processes may be used to fabricate the mode size converter, which may allow for more commercially-viable optical devices.

In accordance with a specific embodiment, the mode size converter design is formed by two cascade-connected inverse tapered couplers. A first coupler may include a silicon nitride waveguide that is combined or hybridized with an inverse taper of a silicon waveguide. A second coupler may include a low index contrast polymer waveguide that is combined or hybridized with an inverse taper of the silicon nitride waveguide. The first and second couplers are connected to each other to form a cascade. This cascade-connected design may provide a 2 decibel (dB) coupling loss for a single-mode fiber misalignment to the second coupler at a tolerance of ±2 micrometers (μm).

Assuming a particular CMOS fabrication/lithography feature limitation, the minimal tip width requirement of the inverse taper of the silicon waveguide and the minimal tip width requirement of the inverse taper of the silicon nitride waveguide may be 150 nanometers (nm) and 350 nm, respectively, according to a specific embodiment. For fabrication/lithography technologies having smaller feature limitations, the minimal tip width requirements could be smaller. Embodiments may be fabricated through CMOS compatible processing to reduce costs. Embodiments may be particularly useful in silicon photonics chips that use a nitride layer as the upper cladding of the silicon waveguide.

In additional embodiments, gray scale photolithography methods may be used, whereby light transmission gradients are utilized to control light exposure latitude so that each point within the exposed area can have light dose ranges from 100% exposure to 0% exposure. Such photolithography technology can be used to fabricate additional three-dimensional mode size converter structures as described herein with very low cost.

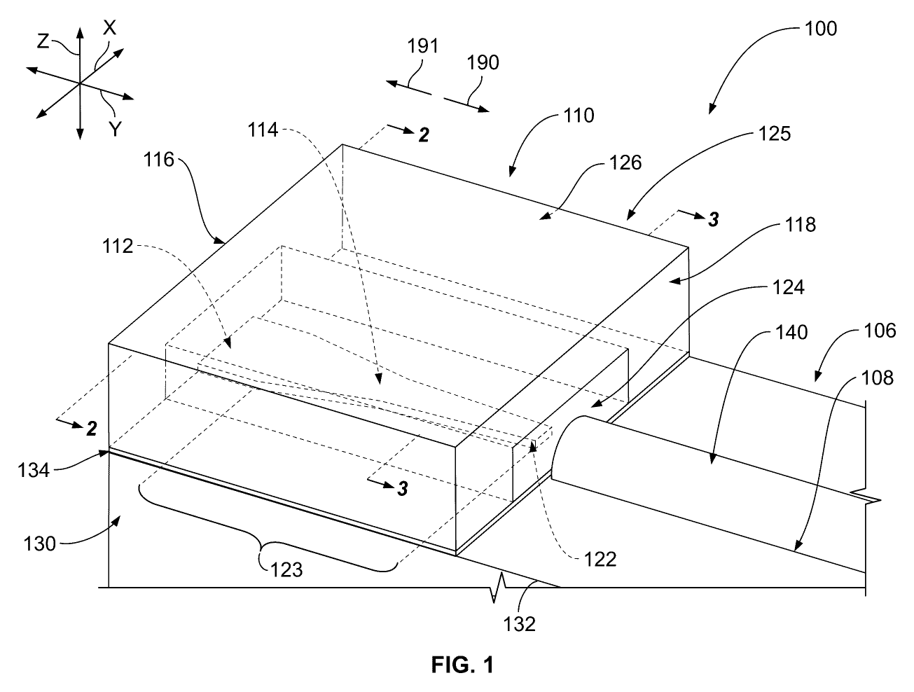

FIG. 1 shows a perspective schematic view of an optical device 100 that includes a fiber support 106 and a mode size converter 110 that is coupled to the fiber support 106. The mode size converter 110 and the fiber support 106 have a fixed relationship with respect to each other. For example, the mode size converter 110 and the fiber support 106 may be part of a single unitary structure. FIG. 1 is an isolated view of the optical device 100. It should be understood that the optical device 100 may include other components (not shown) or the optical device 100 may form part of a larger optical element. For example, the optical device 100 may be, or form part of, a photonic integrated circuit (PIC). The optical device 100 may be used for various applications in optical communication, instrumentation, and signal-processing. For example, the optical device 100 and/or the PIC may be or include optical switches, couplers, routers, splitters, multiplexers/demultiplexers, modulators, amplifiers, wavelength converters, optical-to-electrical signal converters, and electrical-to-optical signal converters.

As shown, the optical device 100 and the mode size converter 110 are oriented with respect to mutually perpendicular X, Y, and Z axes. Lengths of various elements may be measured along the Y axis. Heights or thicknesses of various elements may be measured along the Z axis, and widths of various elements may be measured along the X axis. In some embodiments, the height or thickness of a particular element may be essentially uniform throughout while the width of the element may vary.

The fiber support 106 includes a fiber-receiving channel 108 that is sized and shaped to receive an optical fiber 140. In particular embodiments, the fiber-receiving channel 108 is sized and shaped to receive a single-mode fiber. The fiber-receiving channel 108 or, more specifically, the fiber support 106 is configured to hold the optical fiber 140 at a designated position with respect to the mode size converter 110.

The mode size converter 110 includes a first coupler 112 and a second coupler 114 that are directly connected to each other and form a cascading or step-like optical path. As shown, the mode size converter 110 extends between a first converter face (or end) 116 and a second converter face (or end) 118. In the illustrated embodiment, the first and second converter faces 116, 118 face in opposite directions. In other embodiments, the mode size converter 110 does not end at the first converter face 116 and, instead, material that forms a portion of the mode size converter 110 may extend further. Yet in other embodiments, the first and second converter faces 116, 118 do not face in opposite directions.

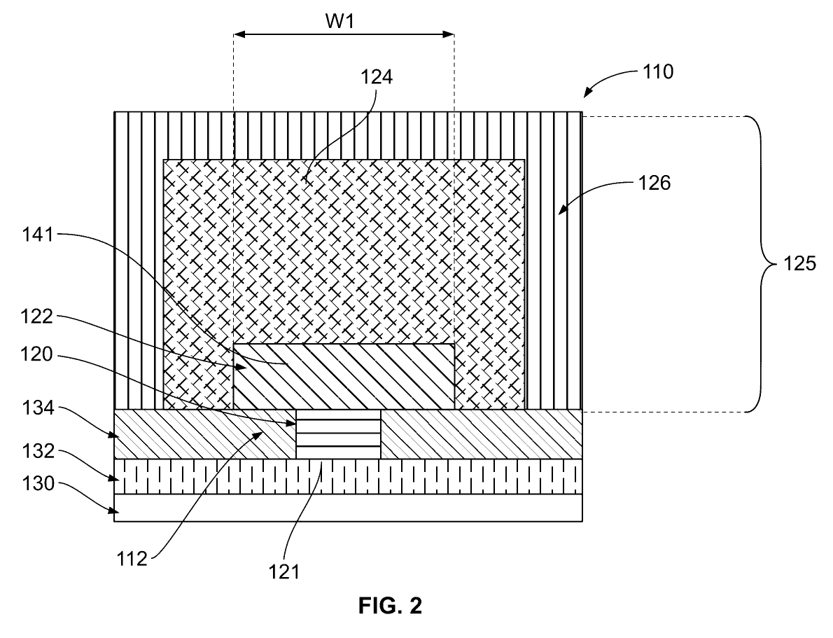

In the illustrated embodiment, the mode size converter 110 includes a signal waveguide 120 (shown in FIG. 2), an intermediate waveguide 122, an overlay waveguide 124, and a cladding 126. The mode size converter 110 may also include a base substrate 130, a support layer 132, and a support layer 134. The support layer 132 is disposed between the base substrate 130 and the support layer 134. Additional layers may be used in other embodiments. In an exemplary embodiment, the signal waveguide 120 may be a silicon waveguide, the intermediate waveguide 122 may be a silicon nitride (Si₃N₄) waveguide, and the overlay waveguide 124 may be a polyimide waveguide. The cladding 126 may be a polyimide waveguide. However, it should be understood that other materials may be used in alternative embodiments.

The materials for each of the waveguides may have a designated refractive index. The refractive index may differ from the refractive index of the material that overlaps the corresponding waveguide. For example, the overlay waveguide 124 and the cladding 126 may have different refractive indexes. The base substrate 130 may be, for example, a silicon wafer handle. The support layer 132 may be a buried oxide layer (BOX), and the support layer 134 may be, for example, an oxide layer. As described below, the optical device 100 and/or the mode size converter 110 may be fabricated using integrated circuit and/or CMOS manufacturing processes.

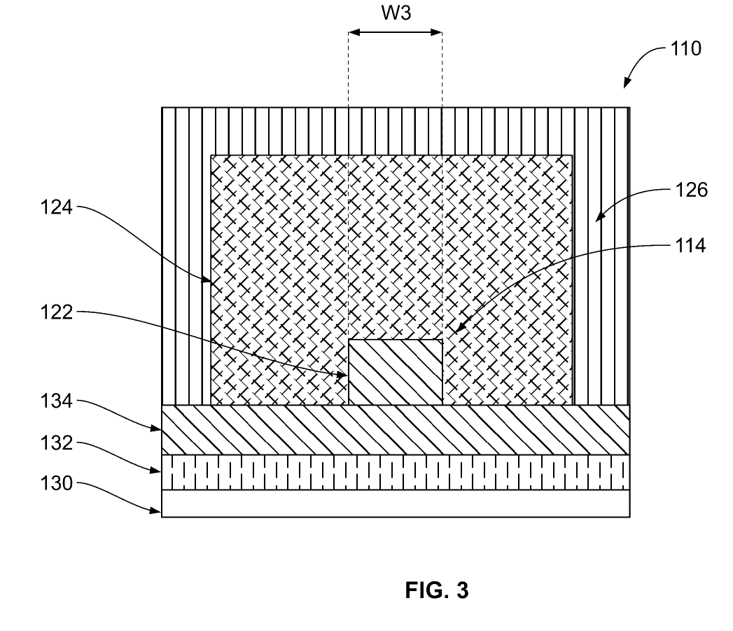

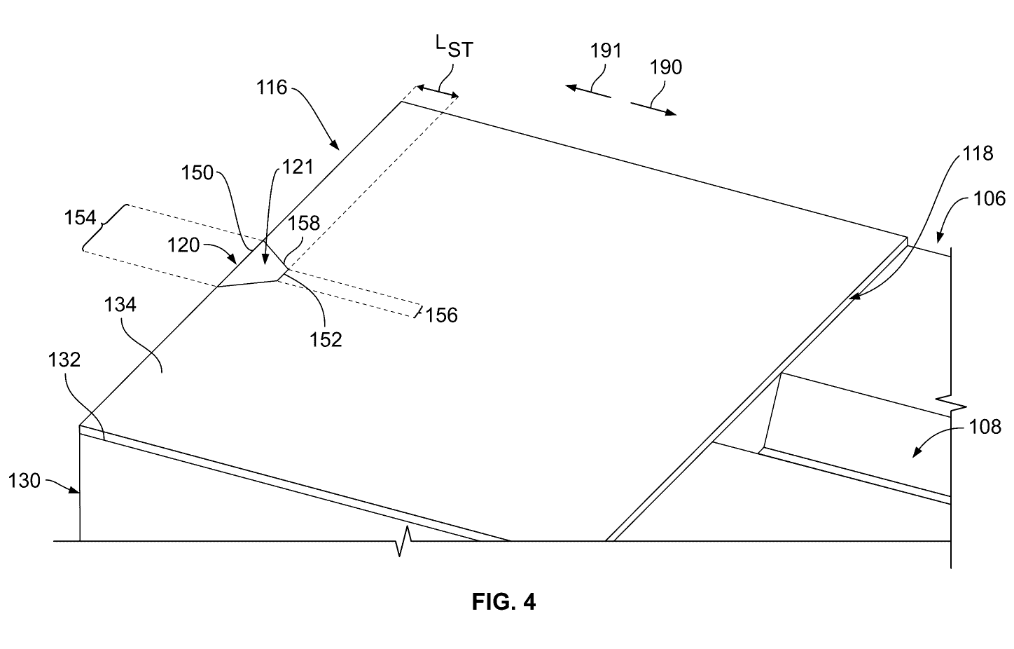

The signal waveguide 120 (FIG. 2) has an inverse taper portion 121 (shown in FIGS. 2 and 4), which is hereinafter referred to as the first inverse taper portion 121. The first inverse taper portion 121 is positioned proximate to the first converter face 116 in the illustrated embodiment. The first inverse taper portion 121 tapers in a light-propagation direction 190 (FIGS. 1 and 4) that is parallel to the Y axis and extends from the first converter face 116 to the second converter face 118. It should be understood, however, that embodiments may allow propagation of light in an opposite light-propagation direction 191. Accordingly, the mode size converter 110 may be configured to receive light from and/or provide light to the optical fiber 140 (FIG. 1).

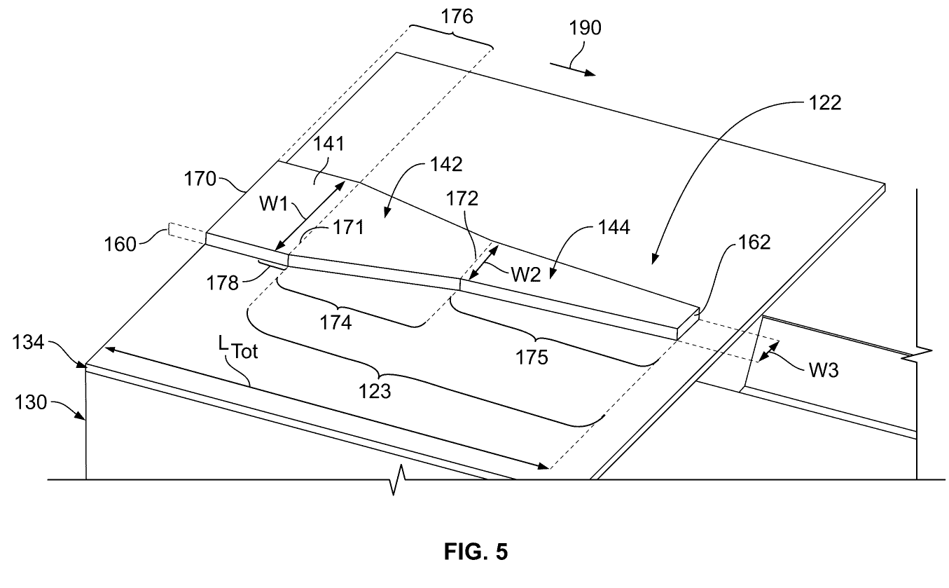

The intermediate waveguide (or shared waveguide) 122 has an inverse taper portion 123 (shown in FIGS. 1 and 5), which is hereinafter referred to as the second inverse taper portion 123. The second inverse taper portion 123 also tapers in the light-propagation direction 190. As used herein, the term “taper portion” refers to a portion of a waveguide that has a cross-sectional area, which is transverse or perpendicular to the propagating light, that changes in size. The taper portion and the overlapping material (e.g., of another waveguide) operate to change the mode size of the propagating light.

The intermediate waveguide 122 is substantially parallel to and overlaps (or overlies) the signal waveguide 120 at the first converter face 116. As shown in FIG. 4, the first inverse taper portion 121 of the signal waveguide 120 extends between a cross-section 150 and a distal end 152. The distal end 152 may also be referred to as the tip of the signal waveguide 120. Although not shown in FIG. 4, the signal waveguide 120 may extend away from the mode size converter 110 in the light-propagation direction 191 toward a remainder of the optical device 100 or another optical element. The cross-section 150 may represent the cross-section of the signal waveguide 120 at which the first inverse taper portion 121 begins to change in size. For example, the first inverse taper portion 121 may have a first taper width 154 at the cross-section 150 and a second taper width 156 at the distal end 152. As an example, the first taper width 154 may be essentially 0.35 μm, and the second taper width 156 may be essentially 0.15 μm. A taper length (L_{ST}) of the first inverse taper portion 121 may be essentially 50 μm, according to a specific embodiment. However, the taper length L_{ST} may have other values, such as 40-100 μm, according to various specific embodiments.

Also shown in FIG. 4, the signal waveguide 120 is positioned within a recess or channel 158 of the support layer 134. In FIG. 5, the intermediate waveguide 122 has been deposited onto the signal waveguide 120 such that the intermediate waveguide 122 overlaps the signal waveguide 120. The intermediate waveguide 122 has also been deposited onto the support layer 134 such that the intermediate waveguide 122 also overlaps the support layer 134.

In FIG. 5, the intermediate waveguide 122 has a guide segment 141 that is coupled to the second inverse taper portion 123 of the intermediate waveguide 122. The second inverse taper portion 123 extends to a distal end 162 of the intermediate waveguide 122. The distal end 162 may also be referred to as the tip of the intermediate waveguide 122. The second inverse taper portion 123 includes a first taper segment 142 and a second taper segment 144. In other embodiment, the second inverse taper portion 123 may include only one taper segment or more than two taper segments.

In the illustrated embodiment, the intermediate waveguide 122 includes only the guide segment 141 and the second inverse taper portion 123. The guide segment 141 has a cross-section taken transverse to the light-propagation direction 190 that is essentially uniform through the guide segment 141. The guide segment 141 extends from a first cross-section 170 of the intermediate waveguide 122 to a second cross-section 171 of the intermediate waveguide 122. The first cross-section 170 may be an end of the intermediate waveguide 122. As shown, the guide segment 141 has a first width W1 that is maintained throughout the guide segment 141 between the first and second cross-sections 170, 171. The intermediate waveguide 122 has a height 160 that is maintained throughout the intermediate waveguide 122. For example, the height may be essentially 0.2 μm.

At the cross-section 171 that joins the guide segment 141 and the first taper segment 142 of the second inverse taper portion 123, the intermediate waveguide 122 has the first width W1. In the exemplary embodiment, the first width W1 is essentially 1 μm. The width of the first taper segment 142 decreases from the first width W1 to a second width W2 at a third cross-section 172 of the intermediate waveguide 122. In the exemplary embodiment, the second width W2 is essentially 0.7 μm. A length 174 of the first taper segment 142 may be 180 μm. The width of the second taper segment 142 decreases from the second width W2 to a third width W3 at the distal end 162. In the exemplary embodiment, the third width W2 is essentially 0.6 μm, and a length 175 of the second taper segment 144 may be 280 μm.

A total taper length L_{Tot} of the intermediate waveguide 122 may range from about 550 to 660 μm, according to various embodiments. The taper length L_{ST} (FIG. 4) of the first inverse taper portion 121 of the signal waveguide 120 may be shorter than the total length L_{Tot} of the intermediate waveguide 122. For example, the taper length L_{ST} of the first inverse taper portion 121 of the signal waveguide 120 is about 30% or less than the taper length L_{Tot}. In specific embodiments, the taper length L_{ST} is less than about 10% of the taper length L_{Tot}. The ratio of the taper length L_{ST} to the taper length L_{Tot} is generally correlated to the effectiveness of the coupling of the light from the signal waveguide 120 to the intermediate waveguide 122. With the taper length L_{ST} being short, there is a sharp taper angle for a given initial taper width relative to the taper tip width, so this taper effectively initiates the light coupling from the signal waveguide 120 to the intermediate waveguide 122. Fundamental transverse electric (TE) mode and transverse magnetic (TM) mode of light in the signal waveguide 120 will be adiabatically transferred into the intermediate waveguide 122 through the inverse silicon taper structure of the first coupler 112.

In some embodiments, the guide element 141 has a length 176 that is greater than the taper length L_{Tot} of the first inverse taper portion 121. More specifically, the cross-section 171 at which the intermediate waveguide 122 begins to taper (or at which the second inverse taper portion 123 begins) is offset with respect to the distal end 152 (FIG. 4) of the first inverse taper portion 121. This offset is referenced at 178 in FIG. 5 and may be, in one particular embodiment, between 10-60 μm. However, the offset may be longer or shorter in other embodiments. In such embodiments, the light propagating through the mode size converter 110 is confined within only the intermediate waveguide 122 for the offset 178. In other embodiments, however, the first and second inverse taper portions 121, 123 may partially overlap such that the distal end 152 of the first inverse taper portion 121 is overlapped by the second inverse taper portion 123.

The intermediate waveguide 122 can have a refractive index (n) that is less than a refractive index of the signal waveguide 120. For example, the refractive index of the intermediate waveguide 122 may be 1.98 or 2.00, and the refractive index of the signal waveguide may be 3.5. The overlay waveguide 124 can have a refractive index that is less than the refractive index of the intermediate waveguide 122. For example, the refractive index of the overlay waveguide 124 may be 1.56. It should be understood that above materials and corresponding refractive indexes are only provided as examples and that other embodiments may include different materials and/or different refractive indexes.

As shown in FIG. 1, the mode size converter 110 may also include a converter waveguide 125 that is applied over the intermediate waveguide 122. The converter waveguide 125 includes the overlay waveguide 124, which may be referred to as a waveguide core 124, and a cladding 126 (FIG. 1). The cladding 126 may be a low index contrast polyimide. The cladding 126 may have a refractive index of 1.54.

In some embodiments, the converter waveguide 125 can have a width of about 8 μm and a height of about 8-9 μm in order to be mode matched to a single-mode fiber (such as SMF-28). The optical mode that was transferred from the signal waveguide 120 to the intermediate waveguide 122 will then be transferred into the waveguide core 124 through the second coupler 114. From there, the optical mode may be coupled to the optical fiber 140. The overlay waveguide 124 (or the waveguide core 124) can be a polyimide (e.g., ULTRADEL 9120D polyimide with n=1.56), formed over the intermediate waveguide 122 and surrounded with a low index contrast over cladding 126 (e.g., ULTRADEL 9020D polyimide with n=1.54), which can be applied over the intermediate waveguide 122 at the first converter face 116 and over the overlay waveguide 124 at the second converter face 118. The signal waveguide 120 and intermediate waveguide 122 can be formed on top of one or more substrates. For example, the signal waveguide 120 can be embedded within a support layer 134 (e.g., oxide layer). In one embodiment, the support layer 134 has a height of about 145 nm. The support layer 134 can be formed over another support layer 132, which can have a thickness of about 2 μm and a refractive index n=1.45. The support layer 132 may comprise buried oxide (BOX). The support layer 132 can be formed over the base substrate 130, which may be a silicon handle wafer. The base substrate 130 may have a refractive index n=3.50, for example.

FIG. 2 illustrates a cross-section proximate to the first converter face 116 of the mode size converter 110 and taken along the line 2-2 in FIG. 1, in accordance with the specific embodiment. As shown in FIG. 2, the base substrate 130 (e.g., silicon handle wafer) has the support layer 132 formed thereon, and the support layer 134 is formed along the support layer 132. The support layer 134 has the signal waveguide 120 formed therein. The signal waveguide 120 is disposed between the intermediate waveguide 122 and the support layer 132 and disposed within the support layer 134. In such an embodiment, the signal waveguide 120 may have the same height as the support layer 134. For example, the height may be 145 nm. The converter waveguide 125, including the overlay waveguide 124 and the cladding 126, is applied directly over the intermediate waveguide 122. The intermediate waveguide 122 has the first width W1.

FIG. 2 illustrates the first coupler 112. The first coupler 112 represents the portion of the mode size converter 110 where the signal waveguide 120 interfaces with the intermediate waveguide 122 or, more specifically, where the first inverse taper portion 121 interfaces with the guide segment 141 of the intermediate waveguide 122. In such embodiments, the first taper portion 121 may not interface with the second inverse taper portion 123 (FIG. 5). In other embodiments, however, the first taper portion 121 may interface with the second inverse taper portion 123.

FIG. 3 illustrates a cross-section of the mode size converter 110 taken along the line 3-3 in FIG. 1, in accordance with the specific embodiment. Similar to FIG. 2, FIG. 3 shows the base substrate 130 with the support layer 132 formed thereon, and the support layer 134 formed on the support layer 132. However, the signal waveguide 120 does not appear in the cross-section of FIG. 3, and the overlay waveguide 124 is applied over the intermediate waveguide 122, which has a third width W3 at a distal end 162 of the second inverse taper portion 123. FIG. 3 illustrates the second coupler 114. The second coupler 114 represents a portion of the mode size converter 110 where the intermediate waveguide 122 interfaces with the surrounding overlay waveguide 124 or, more specifically, where the second inverse taper portion 123 interfaces with the overlay waveguide 124.

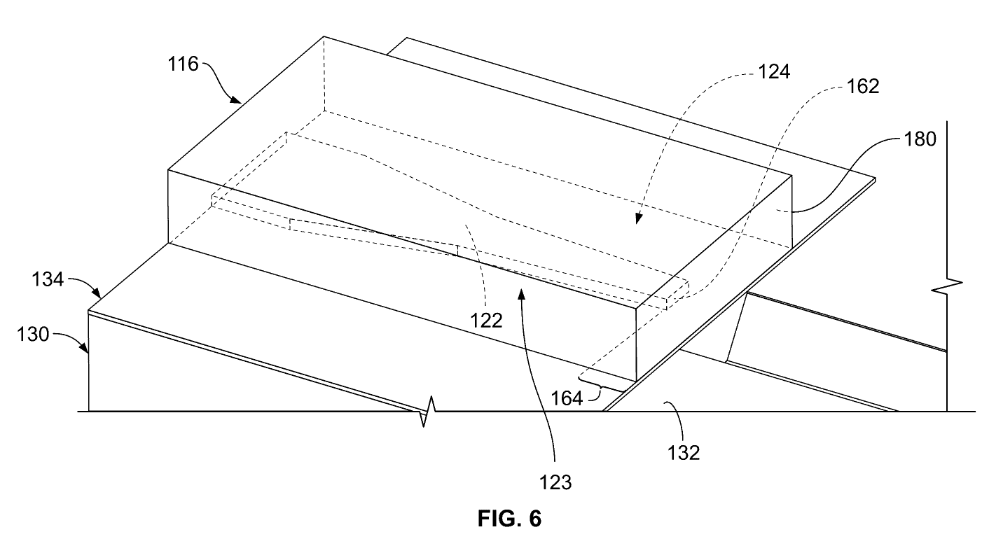

As shown in FIG. 6, the distal end 162 of the second inverse taper portion 123 and an exterior 180 of the overlay waveguide 124 have a distance 164 therebetween. The distance 164 is filled by the material of the overlay waveguide 124. The distance 164 may be, for example, between 10-60 μm. However, it should be understood that the distance may have other values.

FIGS. 4-6 show perspective views of the progressive three dimensional stack-up of various layers and components that form the mode size converter 110 of FIG. 1, according to the specific embodiment. In particular, FIG. 4 illustrates the base substrate 130 having the support layer 132 formed thereon. The base substrate 130 and the support layer 132 have the fiber-receiving channel 108 formed therein for holding and positioning the single-mode fiber 140 (FIG. 1). As such, the fiber support 106 may be defined by the base substrate 130 and the support layer 132. In other embodiments, the fiber support 106 may be discrete with respect to the mode size converter 110 and secured to the mode size converter 110 in a fixed position.

At the first converter face 116, the first inverse taper 121 of the signal waveguide 120 formed within support layer 134 is shown. It should be recognized that the signal waveguide 120 extends to the left beyond the first converter face 116 in FIG. 4, and the first inverse taper portion 121 of the signal waveguide 120 is illustrated. According to a particular embodiment, the signal waveguide 120 tapers from a first taper width 154 of about 0.35 μm to a second taper width 156 of about 0.15 μm. The distal end 152 of the signal waveguide 120 has the second taper width 156. The length L_{ST} of the first inverse taper portion 121 is about 50 μm, but may have other values in alternative embodiments.

As shown in FIG. 5, the intermediate waveguide 122 may be positioned over the signal waveguide 120 and the support layer 134. The guide segment 141 of the intermediate waveguide 122 overlaps the first inverse taper portion 121 of the signal waveguide 120. The first and second taper segments 142, 144 of the intermediate waveguide 122 extend along the support layer 134, according to a specific embodiment. As described herein, the overlapping portions of intermediate waveguide 122 and the first inverse taper portion 121 of the signal waveguide 120 combine to form the first coupler 112.

FIG. 6 is a perspective view of the three dimensional stack-up of the overlay waveguide 124 formed over the intermediate waveguide 122 and on support layer 134. The cladding 126 (FIG. 1) is positioned over the overlay waveguide 124 and the support layer 134 to form the converter waveguide 125 and the mode size converter 110. The cladding 126 and the overlay waveguide 124 (or core of the converter waveguide 125), combined with the second inverse taper portion 123 of the intermediate waveguide 122 to form the second coupler 114. Accordingly, the mode size converter 110 has cascaded-connected inverse tapered couplers 112 and 114. Each of the first and second couplers 112, 114 shares the intermediate waveguide 122.

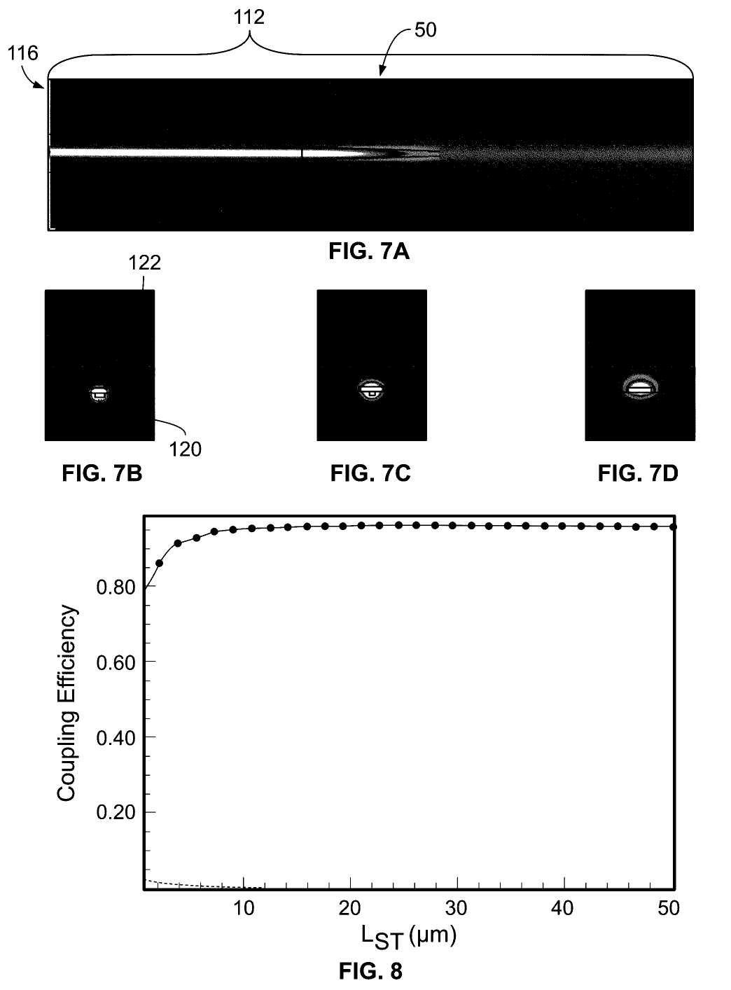

FIG. 7(a) is a simulated field intensity pattern from the top view of the first coupler 112 of mode size converter 110 of FIG. 1. FIG. 7(b) is a simulated field intensity pattern at a cross-section of the signal waveguide 120 (at its widest end) at first converter face 116 of the first coupler 112. FIG. 7(c) is a simulated field intensity pattern at a cross-section of the first coupler 112 at a point (see reference number 50 in FIG. 7(a)). The point 50 is about 10 μm away from the first converter face 116 along the length of signal waveguide 120. FIG. 7(d) is a simulated field intensity pattern at the cross-section having the first taper width W1 of the intermediate waveguide 122 at the end of the first coupler 112 and prior to the first taper segment 142. The operational wavelength for these simulated field intensity patterns is about 1.3 μm. These simulated field intensity patterns demonstrate the conversion of the optical mode between the signal waveguide 120 and the intermediate waveguide 122 as a result of the first coupler 112.

FIG. 8 illustrates the coupling efficiency of the first coupler 112 of the mode size converter 110 in relation to the length L_{ST} of the signal waveguide 120. As shown, there appears to be a strong field overlap between the optical mode in the signal waveguide 120 and the optical mode in the intermediate waveguide 122.

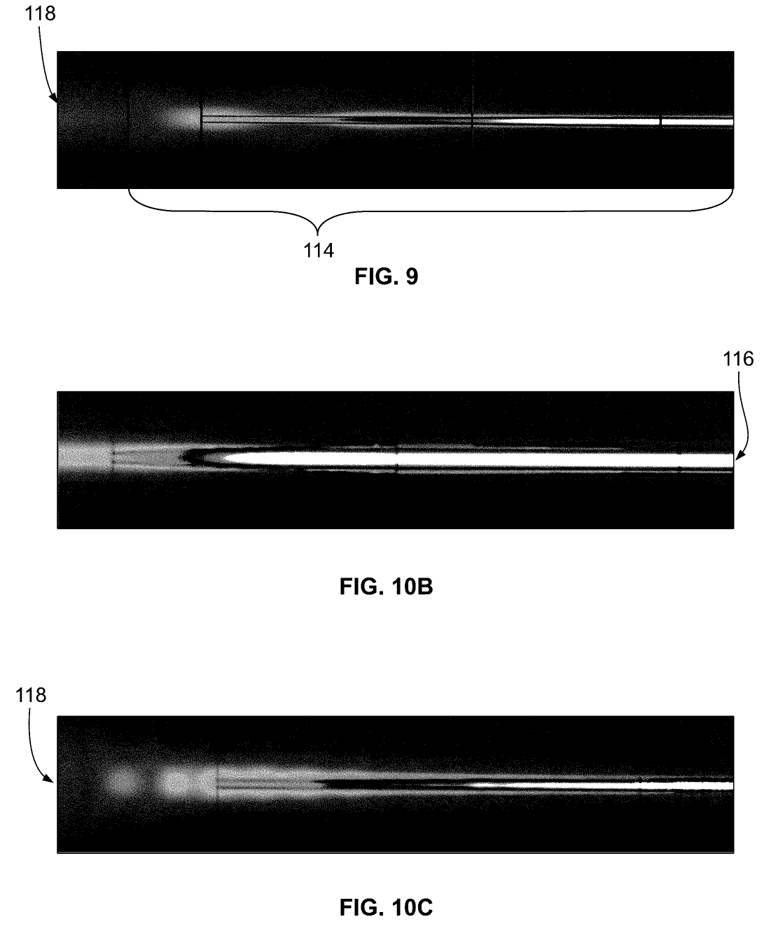

FIG. 9 is a simulated field intensity pattern from the top view of the second coupler 114 of the mode size converter 110. The second converter face 118 is on the left side. FIG. 9 illustrates the simulated field intensity pattern for large mode compatibility with the single-mode fiber in the converter waveguide 125 (FIG. 1), wherein the converter waveguide 125 is a low contrast polymer waveguide.

For the embodiment of FIG. 1, the overall peak coupling efficiency of the mode size converter 110 can be above 85% for the TE mode. With +/−1 μm fiber offset tolerance, the overall coupling efficiency for the TE mode can be around 78%.

Accordingly, in some embodiments, a mode size converter 110 may include a first coupler 112 having a signal waveguide 120 that has a first inverse taper portion 121 and an intermediate waveguide 122 that overlaps the first inverse taper portion 121. The intermediate waveguide 122 has a refractive index that is less than a refractive index of the signal waveguide 120. The mode size converter 110 may also have a second coupler 114 that includes the intermediate waveguide 122 and an overlay waveguide 124. The intermediate waveguide 122 may have a second inverse taper portion 123. The overlay waveguide 124 may overlap the second inverse taper portion 123. The overlay waveguide 124 has a refractive index that is less than the refractive index of the intermediate waveguide 122. The first and second couplers 112, 114 are configured to change a mode size of light propagating through the mode size converter 110. The mode size of the light through the overlay waveguide 124 may be configured to match a mode size of a single-mode fiber 140.

In one aspect, the overlay waveguide 124 has an exterior that is configured to abut the single-mode fiber 140. Optionally, the intermediate waveguide 122 may have a distal end 162. The distal end 162 of the intermediate waveguide 122 and the exterior of the overlay waveguide 124 may have a gap 164 therebetween. The overlay waveguide 124 may fill the gap 164.

In another aspect, the overlay waveguide 124 is a waveguide core, and the mode size converter 110 also includes a cladding 126 that surrounds the waveguide core.

In another aspect, the first inverse taper portion 121 has a distal end 152. The distal end 152 may have a width that is measured transverse to a light-propagation direction 190. For example, the width may be at least 90 nanometers (nm).

In another aspect, the intermediate waveguide 122 may have a guide segment 141 that is coupled to the second inverse taper portion 123. The guide segment 141 may have a cross-section taken transverse to a light-propagation direction 190 that is essentially uniform through the guide segment 141. The second inverse taper portion 123 may have a cross-section that reduces as the second inverse taper portion 123 extends away from the guide segment 141 to a distal end 162 of the intermediate waveguide 122. The guide segment 141 may overlap the first inverse taper portion 121 of the signal waveguide 120.

In another aspect, the first and second inverse taper portions 121, 123 do not overlap each other.

In some embodiments, an optical device 100 may include a first coupler 112 having a signal waveguide 120 that has a first inverse taper portion 121 and an intermediate waveguide 122 that overlaps the first inverse taper portion 121. The intermediate waveguide 122 may have a refractive index that is less than a refractive index of the signal waveguide 120. The optical device 100 may also include a second coupler 114 having the intermediate waveguide 122 and an overlay waveguide 124. The intermediate waveguide 122 has a second inverse taper portion 123. The overlay waveguide 124 overlaps the second inverse taper portion 123. The overlay waveguide 124 has a refractive index that is less than the refractive index of the intermediate waveguide 122. The first and second couplers 112, 114 may form a mode size converter 110 that is configured to change a mode size of light propagating therethrough. The optical device 100 may also include a fiber support 106 having a fiber-receiving channel 108 that is configured to hold an optical fiber 140 for communicating with the mode size converter 110. The fiber support 106 may be held in a fixed position with respect to the mode size converter 110.

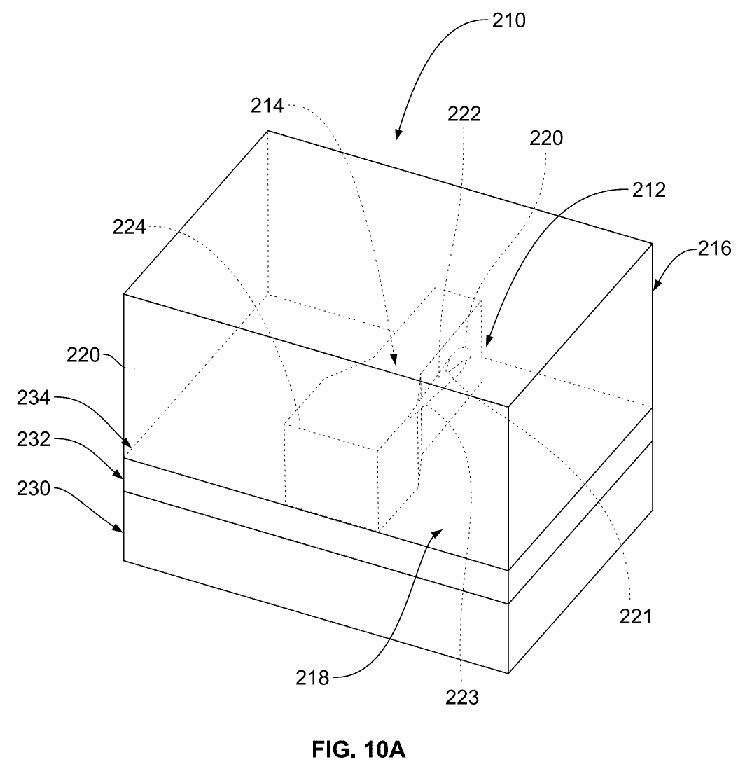

FIG. 10(a) shows a perspective schematic view of a mode size converter 210 having two cascaded inverse tapered couplers 212 and 214, according to another specific embodiment. The mode size converter 210 may have elements that are similar or identical to the elements of the mode size converter 110 (FIG. 1). The mode size converter 210 extends between a first converter face 216 and a second converter face 218. The mode size converter 210 includes a signal waveguide 220 having an inverse taper portion 221 and an intermediate waveguide 222 having an inverse taper portion 223. The intermediate waveguide 222 is substantially parallel to and overlies the signal waveguide 220.

The embodiment of FIG. 10(a) is similar to, and similarly constructed as, the embodiment of FIG. 1 (and similar elements have similar reference numbers as were used in describing the embodiment of FIG. 1). However, the mode size converter 210 includes an overlay waveguide 224 (or waveguide core 224) that also has a tapered shape. Further details regarding elements in the embodiment of FIG. 10(a) which are similar to elements of the embodiment of FIG. 1 are applicable but are not repeated here.

Low index contrast polymer waveguide core 224 may be polyimide or silicon oxynitride, according to various embodiments. As seen in FIG. 10(a), from the first converter face 216 toward the second converter face 218 (where the single-mode fiber would be positioned), the overlay waveguide 224 has height of 8 μm and a first core width of about 4 μm along a first length, generally overlapping the first inverse taper portion 221 and most of the intermediate waveguide 222. The polymer waveguide core 224 then expands to a second core width of about 9 μm along a second length, which overlaps a portion of the intermediate waveguide 222, and then continues with the second core width toward the second converter face (or end) 218.

The tapering of the overlay waveguide 224 can help to increase the interaction between the overlay waveguide 224 and the intermediate waveguide 222. For this specific embodiment, the simulations described below were performed across an operation wavelength spanning from about 1260 to 1360 nm, and the tapering of the overlay waveguide 224 was shown to be useful for optimizing the coupling length of the second coupler 214.

According to this specific embodiment, in this hybridized structure: the silicon inverse tapered waveguide structure 220 goes from 0.35 μm to 0.15 μm along its 100 μm length L_{ST}, and the silicon nitride tapered waveguide 222 goes from 0.35 μm up to 0.8 μm (using two taper portions as described in the embodiment of FIG. 1, or just one taper portion or more than two taper portions according to other embodiments) along its length L_{Tot}. In this embodiment, the silicon nitride tapered waveguide 222 has a width of 0.8 μm along 100 μm, then tapers from 0.8 μm to 0.5 μm along a length of 660 μm, and then further tapers from 0.5 μm to 0.35 μm along a length of 100 μm, for a total length L_{Tot}=860 μm, which is much longer than L_{ST} as described earlier. In this specific embodiment, L_{ST} is less than about 12% of L_{Tot}. It should be noted that in other embodiments, the dimensions provided in the specific embodiments described herein are exemplary and may be different without necessarily departing from the scope of the invention. The top low index contrast polymer waveguide (formed by waveguide core 224 and polymer outer cladding 226) with its second core width interacts with the second inverse taper portion 222 to couple light. In the simulation, the low index contrast polymer waveguide core 224 and outer cladding material 226 have refractive indices of 1.56 and 1.54, respectively.

FIGS. 10(b) and 10(c) respectively show top views of the simulated field intensity patterns in the first coupler 212 and in the second coupler 214 at an operation wavelength of 1.3 μm for this alternate embodiment of FIG. 10(a).

In the first coupler 212, there appears to be a strong field overlap between the optical mode in the first inverse taper portion 221 and the optical mode in the intermediate waveguide 222. In this specific embodiment of FIG. 10(a), the first coupler's coupling efficiency can reach 99.7% for transverse electric (TE) mode and 92% for transverse magnetic (TM) mode while achieving a compact interface, for a given silicon waveguide taper having length L_{ST} of only about 100 μm with a width changing from 0.35 μm to 0.15 μm.

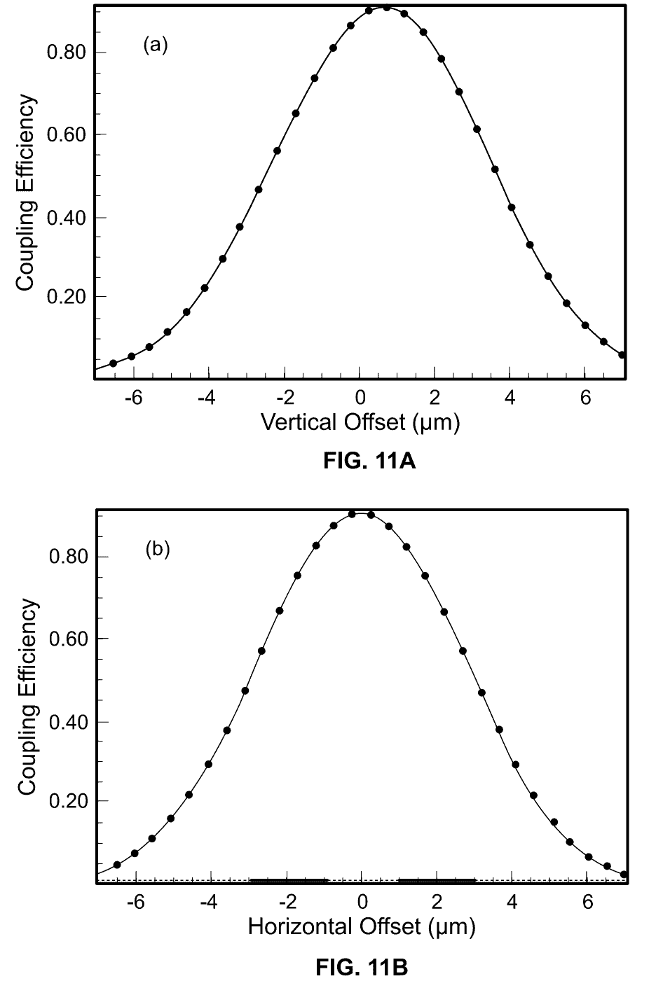

FIGS. 11(a) and 11(b) show the simulated coupling efficiency change with offset of the optical fiber in the vertical and horizontal directions, respectively, for the low index contrast polymer waveguide 224/226 hybridized with the intermediate waveguide 222 of the second coupler 214. Due to the relatively large size of the low index contrast polymer waveguide 224/226 compared to the signal waveguide and the intermediate waveguide, the second coupler 214 of the mode size converter can realize a 2 dB fiber misalignment tolerance above +/−2 μm. In the second coupler 214, the low index contrast polymer waveguide 224/226 hybridized with the intermediate waveguide 222 forms the second coupler 214 and requires a relatively long coupling length to realize a high coupling efficiency. Carefully adjusting different lengths on the taper regions or taper portions of the intermediate waveguide 222 is necessary to optimize the total coupling length of the second coupler 214. For example, if the taper portion 223 of the intermediate waveguide 222 goes from 0.35 μm to 0.5 μm with a taper length around 660 μm, and is then tapered within a portion of the overlay waveguide 224 from 0.5 μm to 0.8 μm with taper length around 100 μm, the coupling efficiency of the second coupler 214 can achieve 92% for the TE mode and 91% for the TM mode.

For the embodiment of FIG. 10(a), the overall peak coupling efficiency of the mode size converter 210 can be calculated as above 90% for TE mode and above 80% for TM mode, and the mode size converter 210 maintains its 2 dB misalignment tolerance above +/−2 μm.

Accordingly, particular embodiments may include a mode size converter having two cascade-connected inverse tapered couplers: one is a silicon nitride waveguide hybridized with a silicon inverse tapered waveguide to form the first coupler, and the second is a low index contrast polymer waveguide hybridized with the silicon nitride inverse tapered waveguide to form the second coupler. This design also gives a 2 decibel (dB) coupling loss for a single-mode fiber misalignment to the second coupler at a tolerance of ±2 micrometers (μm). This mode size converter can be fabricated through CMOS compatible processing to ensure low cost, and will be especially useful in silicon photonics chips that use a nitride layer as the upper cladding of silicon waveguides.

These and other advantages may be realized in accordance with the specific embodiments described as well as other variations. It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

What is claimed is:

1. A mode size converter comprising:
a first coupler including a signal waveguide that has a first inverse taper portion and an intermediate waveguide that overlaps the first inverse taper portion, the intermediate waveguide having a refractive index that is less than a refractive index of the signal waveguide; and
a second coupler including the intermediate waveguide and an overlay waveguide, the intermediate waveguide having a second inverse taper portion, the overlay waveguide overlapping the second inverse taper portion, the overlay waveguide having a refractive index that is less than the refractive index of the intermediate waveguide, the first and second couplers configured to change a mode size of light propagating through the mode size converter, the mode size of the light propagating through the overlay waveguide being configured to match a mode size of a single-mode fiber.

2. The mode size converter of claim 1, wherein the overlay waveguide has an exterior that is configured to abut the single-mode fiber.

3. The mode size converter of claim 2, wherein the intermediate waveguide has a distal end, the distal end of the intermediate waveguide and the end face of the overlay waveguide having a gap therebetween, the overlay waveguide filling the gap.

4. The mode size converter of claim 1, wherein the overlay waveguide constitutes a waveguide core, the mode size converter further comprising a cladding that surrounds the waveguide core.

5. The mode size converter of claim 1, wherein the first inverse taper portion has a distal end, the distal end having a width that is measured transverse to a light-propagation direction, the width being at least 90 nanometers (nm).

6. The mode size converter of claim 1, wherein the intermediate waveguide has a guide segment that is coupled to the second inverse taper portion, the guide segment having a cross-section taken transverse to a light-propagation direction that is essentially uniform through the guide segment, the second inverse taper portion having a cross-section that reduces as the second inverse taper portion extends away from the guide segment to a distal end of the intermediate waveguide, wherein the guide segment overlaps the first inverse taper portion of the signal waveguide.

7. The mode size converter of claim 1, wherein the first and second inverse taper portions do not overlap each other.

8. An optical device comprising:
a first coupler including a signal waveguide that has a first inverse taper portion and an intermediate waveguide that overlaps the first inverse taper portion, the intermediate waveguide having a refractive index that is less than a refractive index of the signal waveguide;
a second coupler including the intermediate waveguide and an overlay waveguide, the intermediate waveguide having a second inverse taper portion, the overlay waveguide overlapping the second inverse taper portion, the overlay waveguide having a refractive index that is less than the refractive index of the intermediate waveguide, wherein the first and second couplers form a mode size converter that is configured to change a mode size of light propagating therethrough; and
a fiber support having a fiber-receiving channel that is configured to hold an optical fiber for communicating with the mode size converter, the fiber support being held in a fixed position with respect to the mode size converter.

9. The optical device of claim 8, wherein the overlay waveguide has an end face that is configured to abut the optical fiber when the optical fiber is disposed in the fiber-receiving channel, the mode size of the light through the overlay waveguide being configured to match a mode size of the optical fiber.

10. The optical device of claim 8, wherein the overlay waveguide is a waveguide core, the mode size converter further comprising a cladding that surrounds the waveguide core.

11. The optical device of claim 10, wherein the waveguide core and the cladding form a converter face that is configured to abut the optical fiber.

12. The optical device of claim 8, wherein the first inverse taper portion has a distal end, the distal end having a width that is measured transverse to a light-propagation direction, the width being at least 90 nanometers (nm).

13. The optical device of claim 8, wherein the intermediate waveguide has a guide segment that is coupled to the second inverse taper portion, the guide segment having a cross-section taken transverse to a light-propagation direction that is essentially uniform through the guide segment, the second inverse taper portion having a cross-section that reduces as the second inverse taper portion extends away from the guide segment to a distal end of the intermediate waveguide, wherein the guide segment overlaps the first inverse taper portion of the signal waveguide.

14. The optical device of claim 8, wherein the first and second inverse taper portions do not overlap each other.

15. The optical device of claim 8, wherein the fiber-receiving channel is sized and shaped to receive a single-mode fiber.

16. A mode size converter having a first end and a second end, the mode size converter comprising:
a silicon waveguide having an inverse taper from the first end;
a silicon nitride waveguide having an inverse taper relative to the first end, the silicon nitride waveguide adjacent and substantially parallel to the silicon waveguide, wherein an overlapping of the silicon waveguide and silicon nitride waveguide form a first coupler; and
a polymer waveguide comprising a core and a cladding, said core adjacent and substantially parallel to the silicon nitride waveguide, and said cladding formed over said core, wherein an overlapping of the silicon nitride waveguide and the polymer waveguide form a second coupler; and
wherein said first coupler and said second coupler are cascaded.

17. The mode size converter of claim 16, wherein a width of the inverse taper of the silicon waveguide goes from about 0.15 μm to about 0.35 μm for a length of the inverse taper of the silicon waveguide of about 50-100 μm.

18. The mode size converter of claim 16, wherein the silicon nitride waveguide tapers from a width of about 0.8-1 μm at the first end to between about 0.35-0.7 μm at the second end.

19. The mode size converter of claim 16, wherein the silicon nitride waveguide tapers from a width W1 at the first end to a width W2 over a first distance, then from W2 to a width W3 over a second distance.

20. The mode size converter of claim 16, wherein the silicon nitride waveguide has a height of about 200 nm.
